(19) United States
(12) Patent Application Publication
(10) Pub. No.: US 2005/0073500 A1
(43) Pub. Date: Apr. 7, 2005

(54) Computer mouse with detachable top

(76) Inventor: Devron Philo, Aubrey, TX (US)

Correspondence Address: Raffi J. Gostanian, Jr.;Jackson Walker, L.L.P., Suite 600, 2435 North Central Expressway, Richardson, TX, 75080, US

(21) Appl. No.: 10/677,415

(22) Filed: Oct. 2, 2003

(51) Int. Cl. G09G 5/08

(52) U.S. Cl. 345/163

(57) ABSTRACT

The present invention discloses a face or top portion for a computer mouse that is detachably attached onto a bottom portion of the computer mouse. The top portion and bottom portion comprise a shell that encloses electronics and other parts found in a conventional computer mouse. The detachable face can be displayed with a variety of logos and words for personalization and/or advertising purposes and a plurality of detachable faces can be used with the bottom portion. The mouse, which is used on a home or office computer, laptop, or other electronic device, is made of plastic or other materials and has a multi-button finger mechanism including a scrolling button if desired. The detachable top portion has a hole in its rear for connection to a fastening member on the bottom portion of the mouse.

### BACKGROUND OF THE INVENTION

1. Field of the Invention

The present invention relates generally to a computer mouse, and, more specifically, is concerned with a computer mouse having a detachable top.

2. Description of the Prior Art

Computer mice and covers have been described in the prior art, however, none of the prior art devices disclose the unique features of the present.

In U.S. Pat. No, 6,118,431, dated Sep. 12, 2000, Terrier, et al., disclosed a detachable casing capable of adapting to a computer mouse type peripheral by covering it partially. This casing comprises, firstly, at least one pressure sensor to measure the pressure exerted on this pressure sensor by an operator's hand and, secondly, linking means to address the signals coming from this sensor to the computer. The casing is inexpensive and highly ergonomical. It enables the possibilities of use of a computer to be greatly extended by increasing the number of controls performed with only one hand.

In U.S. Pat. No. 6,043,808, dated Mar. 28, 2000, Perry disclosed a flexible membrane which extends over the upper surface of a mouse pad and a mouse resting on the pad in order to keep the mouse pad clean and prevent contamination of the mouse ball with dirt and other foreign matter.

In U.S. Pat. No. 6,256,015 Bi, dated Jul. 3, 2001, Adler disclosed a cover for a computer mouse which has a concave-convex shell having a concave lower surface shaped to conform generally to the upper surface of a computer mouse and a front section that tapers forwardly and downwardly from a front end of the mouse to form a rounded nose. The shell has two aperatures suggestive of eyes extending through it, each overlying a respective one of two finger-actuated buttons on the mouse, and through which, in one embodiment, the buttons on the mouse can be manipulated by the fingers of a user's hand. The shell further includes a pair of parallel, longitudinal depressions suggestive of ears formed on its upper surface. The depressions extend rearward from a corresponding one of the aperatures, and are respectively adapted to receive the lower surface of a respective one of the user's fingers and align it with a respective one of the buttons.

In U.S. Pat. No. 6,099,934, dated Aug. 8, 2000, Held disclosed a cover for a computer mouse utilizing a sheath having a first portion extending over the side portion of the mouse. A flap connects to the sheath and includes a notch which aligns with portions of the switch actuators on the mouse to permit access to the same. A fastener is also employed to anchor the sheath and connected flap to the cord of the mouse. The flap provides a surface for presentation of indicia or for attachment of three-dimensional objects. Such three-dimensional objects may be attached directly to the upper surface of the computer mouse.

While these mice and their detachable tops may be suitable for the purposes for which they were designed, they would not be as suitable for the purposes of the present invention, as hereinafter described.

### SUMMARY OF THE PRESENT INVENTION

The present invention discloses a face or top portion for a computer mouse that is detachably attached onto a bottom portion of the computer mouse. The top portion and bottom portion comprise a shell that encloses electronics and other parts found in a conventional computer mouse. The detachable face can be displayed with a variety of logos and words for personalization and/or advertising purposes and a plurality of detachable faces can be used with the bottom portion. The mouse, which is used on a home or office computer, laptop, or other electronic device, is made of plastic or other materials and has a multi-button finger mechanism including a scrolling button if desired. The detachable top portion has a hole in its rear for connection to a fastening member on the bottom portion of the mouse.

An object of the present invention is to provide an advertising surface for use on a top portion covering a conventional mouse whereon advertising or personalization is appropriate. Furthermore, an object of the present invention is to provide for a detachable face covering a conventional mouse.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is an elevation view of the front of the top of the present invention;

FIG. 2 is an elevation view of the rear of the top of the present invention;

FIG. 3 is an elevation view of the side of the top of the present invention;

FIG. 4 is a perspective view of the front of the bottom of the present invention;

FIG. 5 is a perspective view of the rear of the bottom of the present invention;

FIG. 6 is perspective view of the side of the bottom of the present invention; and

FIG. 7 is a partial plan view of the top of the present invention.

### LIST OF REFERENCE NUMERALS

With regard to reference numerals used, the following numbering is used throughout the drawings:
10 present invention
12 top
14 left button
16 right button
18 scrolling roller
19 prongs
20 hole
22 bottom
24 button
26 notches
28 mouse cord
30 logo

### DETAILED DESCRIPTION OF THE PREFERRED EMBODIMENT

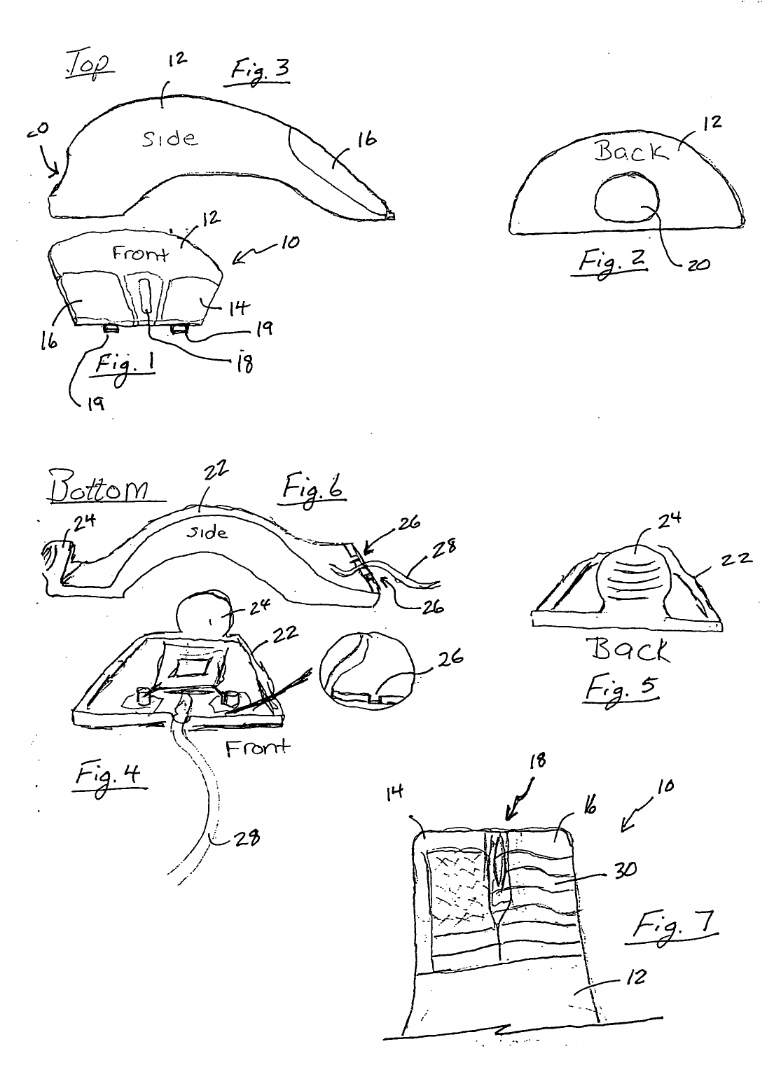

In order that the invention may be more fully understood, it will now be described, by way of example, with reference to the accompanying drawings in which FIGS. 1 through 7 illustrate the present invention wherein a detachable top for a conventional mouse is disclosed.

Turning to FIGS. 1-3, shown therein are views of the top of the mouse of the present invention 10 wherein a detachable face for a conventional mouse for use with a home or office computer is shown. The present invention is made of hard plastic or the like and utilizes a two-button conventional (i.e., left click-right click mouse) finger mechanism including a scrolling roller if desired. FIG. 1 shows the front of the top 12 of the present invention 10 having a left button 14, a right button 16 and a central scrolling roller 18 if desired. Also shown are prongs 19 for use in connecting the top 12 to the bottom of the mouse. In an alternate embodiment, the mouse may have more or less than two buttons. FIG. 2 shows a rear view of the top 12 of the present invention having a hole 20 therein which hole receives a button-like member therein which button is attached to the bottom of the mouse and is used as a locking means for the present invention. FIG. 3 shows a side view of the top 12 of the present invention showing the right button 16 along with the hole 20 which receives a button as previously disclosed. In an alternate embodiment, other locking means may be used instead of the hole 20 and the button-like member such as a clipping or snapping apparatus whereby a bottom portion of the inside of the top 12 includes at least one protrusion that is detachably attached to a bottom portion of the mouse. Further, the top portion may be slidably attached and detached to and from the bottom portion of the mouse.

Turning to FIGS. 4-6, shown therein are views of the bottom of the mouse of the present invention. FIG. 4 shows the bottom 22 of the present invention having the button 24 attached to the rear thereof for operative connection to the hole 20 which was previously disclosed as a part of the top of the present invention. Also shown are notches 26 on the front of the bottom 22 of the present invention which are used as additional connecting means for attaching the top 12 to the bottom 22 of the present invention. Further shown is the mouse cord 28 which is adapted to be attached to a computer and a hole adapted to engage a roller-ball. FIG. 5 shows the rear of the bottom 22 of the present invention showing the button 24. FIG. 6 shows a side view of the bottom 22 of the present invention showing the button 24 on the rear of the bottom 22 along with the notches 26 on the front of the bottom of the present invention along with the mouse cord 28 in a port that is used to attach to a computer Universal Serial Bus. In an alternate embodiment, the mouse may be a wireless enabled mouse, such as an optical, infrared, Bluetooth, or Wi-Fi enabled mouse. In such a case, a port in the top portion, the bottom portion, or a combination of the top portion and the bottom portion containing conventional elements is adapted to provide wireless connectivity to a computer.

Turning to FIG. 7, shown therein is a plan view of the present invention 10 showing a portion of the front top of the mouse having a left button 14 and a right button 16 thereon along with the scrolling wheel or roller 18. Also shown is an exemplary logo 30 attached to the detachable top 12 of the mouse of the present invention which logo is used for advertising purposes or for personalization of the top of the present invention. In an alternate embodiment, the mouse may not contain the scrolling wheel or roller 18 or may contain other elements adapted to control various computer related actions.

By way of a description of the operation of the present invention it should be clear that the top of the mouse of the present invention has a small hole 20 in its rear that acts as a locking means when attached to the button 24 on the bottom 22 of the present invention. The user pushes the button 24 to detach the face from the mouse so that the detachable face will then simply pop off of the mouse. The front of the top of the mouse has two prongs 19 which prongs fit into the notches 26 on the front of the bottom of the mouse whereby the prongs 19 will guide the top piece to fit in the proper orientation and manner with the bottom piece so that the detachable face is firmly attached to the bottom of the mouse. The logo 30 can be a printed or silk screened logo being a logo or design that individualizes the mouse to the individual consumer or user. Internally, the mouse of the present invention is a conventional mouse which uses standard electrical components and mechanisms as would be provided in the standard manner by one skilled in the art.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the detachable top may consist of a single piece or a plurality of pieces. Also, one or more logos may be provided on one or more portions of the detachable top(s). For example, the logo(s) may be situated on the portion of the detachable top that is partially covered by a user's palm when in use or on each individual mouse button. Further, the detachable top of the present invention can be formed in various shapes and sizes in order to fit the bottom portion of nearly any computer mouse. Also, logos, words, or other images can appear on the bottom portion of the mouse, side portions of the mouse (where the side portions are a part of the top portion, the bottom portion, or both the top portion and the bottom portion). Still further, the logos, words, or other images appearing on multiple portions of the mouse, can be made to appear continuous and smooth to appear as a single portion instead of multiple portions. Also, the bottom portion may consist of a common logo, word, or image on top of which multiple top portions with different logos, words, or images could be placed and still appear continuous or smooth. Still further, the mouse can be adapted to provide computer functionality to a plurality of devices at a plurality of locations.

1. A computer mouse, comprising:
a top portion;
a bottom portion;
wherein the top portion is quickly detachably attached to the bottom portion; and
wherein the top portion and the bottom portion enclose elements adapted to provide computer mouse functionality.

2. The computer mouse of claim 1, further comprising at least one button on the top portion.

3. The computer mouse of claim 1, further comprising a hole in a back portion of the top portion.

4. The computer mouse of claim 3, further comprising a button-like member attached to the bottom portion.

5. The computer mouse of claim 4, wherein the hole is adapted to receive the button-like member in order to secure the top portion to the bottom portion.

6. The computer mouse of claim 1 further comprising at least one prong coupled to the top portion.

7. The computer mouse of claim 6, wherein the at least one prong is adapted to couple to the bottom portion in order to secure the top portion to the bottom portion.

8. The computer mouse of claim 1 further comprising at least one of the following elements depicted on the top portion from a group consisting of:
a logo;
a word;
an image; and
any combination of a logo, a word, or an image.

9. The computer mouse of claim 1, wherein the top portion is comprised of a plurality of portions.

10. The computer mouse of claim 1, wherein the bottom portion is comprised of a plurality of portions.

11. A device, comprising:
a top portion;
a bottom portion;
wherein the top portion and the bottom portion are adapted to display a logo, a word, an image, or any combination of a logo, a word, or an image;
wherein the top portion is quickly detachably attached to the bottom portion; and
wherein the top portion and the bottom portion enclose elements adapted to provide computer functionality.

12. The device of claim 11, wherein the device is adapted to communicate with a computer via a wired connection.

13. The device of claim 11, wherein the device is adapted to communicate with a computer via a wireless connection.

14. The device of claim 11, wherein the top portion and the bottom portion are detachably attached to each other via at least one of a following element associated with the top portion, the bottom portion, or both the top portion and the bottom portion, from a group consisting of:
a hole and a button-like member;
at least one prong;
at least one clipping apparatus;
at least one snapping apparatus; and
at least one protrusion.

15. The device of claim 14, wherein the button-like member can be pushed to detach the top portion from the bottom portion.

16. The device of claim 11, wherein the logo, the word, the image, or any combination of the logo, the word, or the image is printed.

17. The device of claim 11, wherein the logo, the word, the image, or any combination of the logo, the word, or the image is silk screened.

18. The device of claim 11, wherein the device is adapted to provide computer functionality to a plurality of devices at a plurality of locations.

19. A computer mouse containing standard electrical components and mechanisms, the mouse comprising:
a top portion comprising a hole;
a bottom portion comprising a button-like member, wherein the button like member is adapted to engage the hole to secure the top portion to the bottom portion; and
a port in the top portion, the bottom portion, or a combination of the top portion and the bottom portion adapted to provide connectivity to a computer.

20. The computer mouse of claim 19 further comprising a hole in the bottom portion adapted to engage a roller-ball.
